(19) United States
(12) Patent Application Publication
(10) Pub. No.: US 2014/0017544 A1
(43) Pub. Date: Jan. 16, 2014

(54) Hydrogen Recombinator

(71) Applicants: Lauren W. Hart, San Francisco, CA (US); Daniel MacKellar, Saanich (CA); Andrew Bollman, San Francisco, CA (US); Paul Kreiner, San Francisco, CA (US); Jonathan Hall, San Mateo, CA (US); Victor Martino, San Jose, CA (US); Kyle Haynes, Redwood City, CA (US)

(72) Inventors: Lauren W. Hart, San Francisco, CA (US); Daniel MacKellar, Saanich (CA); Andrew Bollman, San Francisco, CA (US); Paul Kreiner, San Francisco, CA (US); Jonathan Hall, San Mateo, CA (US); Victor Martino, San Jose, CA (US); Kyle Haynes, Redwood City, CA (US)

(73) Assignee: Primus Power Corporation, Hayward, CA (US)

(21) Appl. No.: 13/549,843

(22) Filed: Jul. 16, 2012

(51) Int. Cl. H01M 10/36; C01B 7/09; H01M 8/20; C01B 7/00

(52) U.S. Cl. 429/105; 423/487; 422/211; 422/187

(57) ABSTRACT

A recombinator for a flow battery including at least one input configured to provide a halogen containing flow stream and hydrogen gas to a reaction chamber and a substrate located in the reaction chamber. The substrate is configured to be directly heated and the substrate contains a catalyst. The recombinator is configured to react the hydrogen gas and the halogen using the catalyst to form a hydrogen-halogen compound.

### FIELD

The present invention is generally directed to flow battery system components and more specifically to a device that recombines hydrogen gas with halogen gas generated during operation of a flow battery.

### BACKGROUND

The development of renewable energy sources has revitalized the need for large-scale batteries for off-peak energy storage. The requirements for such an application differ from those of other types of rechargeable batteries such as lead-acid batteries. Batteries for off-peak energy storage in the power grid generally are required to be of low capital cost, long cycle life, high efficiency, and low maintenance.

One type of electrochemical energy system suitable for such an energy storage application is a so-called “flow battery” which uses a halogen component for reduction at a normally positive electrode, and an oxidizable metal adapted to become oxidized at a normally negative electrode during the normal operation of the electrochemical system. An aqueous metal halide electrolyte is used to replenish the supply of halogen component as it becomes reduced at the positive electrode. The electrolyte is circulated between the electrode area and a reservoir area. One example of such a system uses zinc as the metal and chlorine as the halogen. Another example uses zinc as the metal and bromine as the halogen.

Such electrochemical energy systems are described in, for example, U.S. Pat. Nos. 3,713,888, 3,993,502, 4,001,036, 4,072,540, 4,146,680, 4,414,292 and 8,114,541 the disclosures of which are hereby incorporated by reference in their entirety.

### SUMMARY

An embodiment relates to a recombinator for a flow battery including at least one input configured to provide a halogen containing flow stream and hydrogen gas to a reaction chamber and a substrate located in the reaction chamber. The substrate is configured to be directly heated and the substrate contains a catalyst. The recombinator is configured to react the hydrogen gas and the halogen using the catalyst to form a hydrogen-halogen compound.

Another embodiment relates to a method of operating a recombinator. The method includes providing a halogen containing flow stream to a recombinator including a directly heated substrate having a catalyst, providing hydrogen gas to the recombinator and reacting the halogen with the hydrogen gas using the catalyst to form a hydrogen-halogen compound.

Another embodiment relates to recombinator for a flow battery. The recombinator includes at least one input configured to provide a halogen containing flow stream and hydrogen gas to a reaction chamber and a substrate located in the reaction chamber. The substrate contains a substantially platinum free metal oxide catalyst. The recombinator is configured to react the hydrogen gas and the halogen using the catalyst to form a hydrogen-halogen compound.

### BRIEF DESCRIPTION OF THE DRAWINGS

FIG. 1A is a three dimensional perspective view of a recombinator according to an embodiment; FIG. 1B is a schematic side cross sectional view of the recombinator of FIG. 1A.

FIG. 2A is a schematic diagram illustrating a method of operation of the recombinator of FIGS. 1A and 1B according to an embodiment.

FIG. 2B is a schematic diagram illustrating a method of operation of the recombinator of FIGS. 1A and 1B according to another embodiment.

FIG. 3A is a top cross sectional view illustrating a spiral substrate for use in a recombinator according to an embodiment; FIG. 3B is a photograph illustrating details of a portion of the spiral substrate illustrated in FIG. 3A.

FIG. 4 is a schematic diagram illustrating operation of a flow battery system during charge mode according to an embodiment.

FIG. 5 is a schematic diagram illustrating operation of a flow battery system during charge mode according to another embodiment.

FIG. 6 is a schematic diagram of the flow battery system of FIG. 5 illustrating the operation during discharge mode.

### DETAILED DESCRIPTION

During operation of aqueous zinc-halogen flow batteries, water may be electrolyzed, resulting in the formation of hydrogen gas and a reduction in the acid concentration of the aqueous electrolyte. However, if the acid concentration in the flow battery drops too low, the zinc forms a poor, “mossy” deposit on recharging. To keep the pH substantially constant, hydrogen gas produced by electrolysis may be reacted with a halogen (e.g., bromine and chlorine) in a recombinator to form a hydrogen halide (e.g., hydrogen bromide and/or hydrogen chloride). The hydrogen halide may then be added back to the aqueous electrolyte. On mixing with the aqueous electrolyte the hydrogen halide may form an acid compound (e.g., hydrobromic acid).

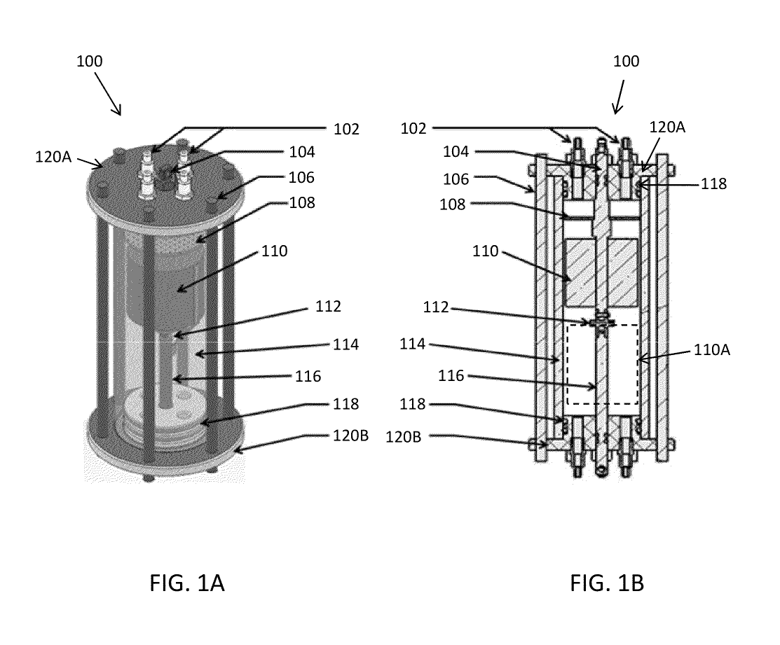

FIGS. 1A and 1B illustrate a recombinator 100 according to an embodiment of the invention. The recombinator 100 includes one or more gas inlets 102, such as 2, 3, 4, 5, 6 or more gas inlets 102. In an embodiment, a halogen vapor (i.e., gas) is introduced into the recombinator 100 through one or more gas inlets 102. Hydrogen gas is also introduced to the recombinator 100 via the same one or more gas inlets 102. Alternatively, the halogen and the hydrogen may be introduced to the recombinator 100 through separate gas inlets 102. That is, the halogen and the hydrogen may be separately introduced to the recombinator 100. The one or more gas inlets 102 pass through a first end cap 120A located on one side of a housing 114. The housing may be made of any suitable material, such as high temperature glass, plastic, ceramic, etc. The end caps 120A, 120B may be made of any suitable material, such as PTFE. Preferably, the recombinator 100 includes one or more seals 118, such as gaskets or O-rings, between the first end cap 120A and the housing 114 to prevent gas leaks from the recombinator 100. The seals 118 are preferably made of a resilient material, such as Viton rubber, Teflon™ and the like. A second end cap 120B is located on the opposite side of the housing 114 from the first end cap 120A. Preferably, as with the first end cap 120A, one or more seals 118, such as gaskets or O-rings, are located between the second end cap 120B and the housing 114 to prevent gas leaks from the recombinator 100.

In an embodiment, the two end caps 120 are held in place adjacent to the housing 114 with tie rods 106. Alternatively, any other connectors, such as screw(s), bracket(s) adhesive, etc. may be used. The tie rods 106 may be secured with bolts or screws or any other suitable fastening device. Located below the first end cap 120A is a diffuser 108. The diffuser 108 receives gas (i.e., the halogen and hydrogen) from the gas inlets 102 and disperses this gas. That is, the diffuser 108 spreads the flow of the gas across a plane perpendicular to the incoming flow of gas to the recombinator 100, thereby providing a more even gas flow through the recombinator 100. The diffuser 108 may be a perforated plate, cylinder or any other diffuser.

Located below the diffuser 108 is a first substrate 110. The substrate 110 may be made of any material which can be resistively heated to a temperature suitable for the catalytic reaction of hydrogen with a halogen. Suitable materials include, but are not limited to, titanium and tantalum.

The substrate 110 is preferably coated with a catalyst that catalyzes the hydrogen-halogen reaction. Preferably, the catalyst includes a metal oxide. The metal oxide may include one or more oxides of ruthenium, iridium, titanium, tantalum, tin, tungsten, aluminum, zirconium, molybdenum, palladium, and silicon (which is considered a metal rather than a semiconductor for ease of definition herein). Alternatively, the catalyst may be a mixed metal oxide (MMO) which includes two or more oxides of ruthenium, iridium, titanium, tantalum, tin, tungsten, aluminum, zirconium, molybdenum, palladium, and silicon. In an embodiment, the catalyst is substantially platinum free, such that the catalyst includes less than 1 wt % platinum. Conventional systems use platinum as a catalyst. However, a trace amount of platinum in the electrolyte interferes with the zinc plating reactions and degrades battery performance. In contrast, catalytic coatings without platinum are compatible with the zinc plating process, their use eliminating a concern of catalyst material poisoning the electrolyte stream.

The substrate 110 preferably has a large surface area to facilitate the reaction of the hydrogen with the halogen. In an embodiment, the substrate 110 is made of a mesh. Alternatively, the substrate 110 may be made of a corrugated metal (i.e., the substrate is fan folded to have a series of alternating ridges and valleys).

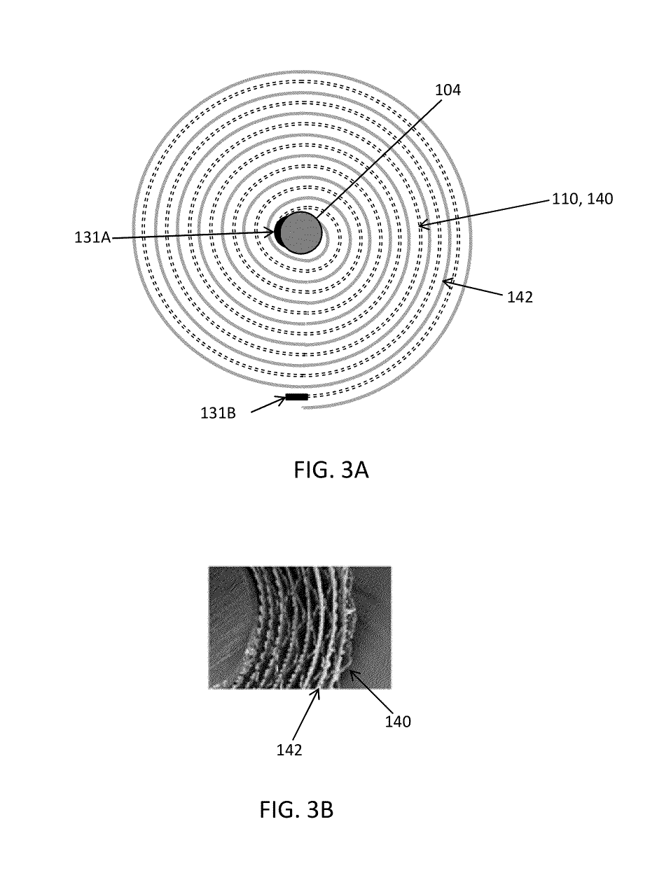

In an embodiment, the substrate 110 is configured as a spiral 140 (e.g., a coil, FIGS. 3A, 3B). The spiral configuration may be combined with the mesh and/or corrugated embodiments. That is, the substrate 110 may comprise spiral of mesh material, corrugated material, or corrugated mesh material (e.g. metal oxide coated titanium corrugated mesh). Preferably, when in a spiral configuration, a layer of electrical insulation 142 is provided such that adjacent layers of the substrate 110 in the spiral 140 are separated from each other by an intervening layer of electrical insulation 142, such as PTFE or another high temperature stable polymer layer or mesh. This may be accomplished, for example, by placing a layer of electrical insulation 142 on the corrugated and/or mesh substrate 110 prior to rolling the substrate 110 into a spiral and subsequently rolling the flexible mesh substrate 110 and the electrical insulation 142 into a spiral. In this manner, short circuits across adjacent layers may be prevented.

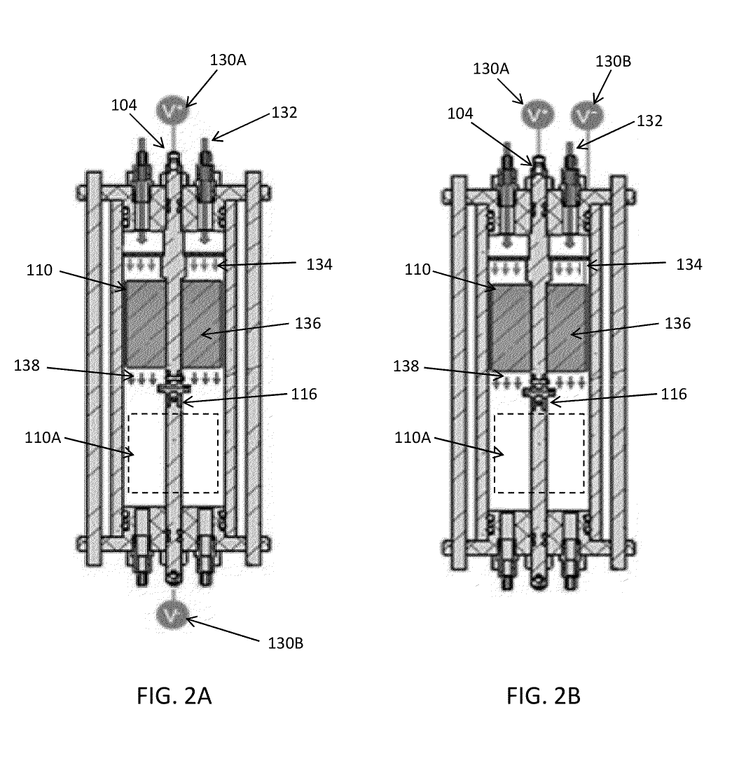

In an embodiment, the substrate 110 is mounted in the housing 114 with two conductor rods 104, 116. The conductor rods 104 and 116 are made of an electrically conductive material, such as metal and provide electricity to the substrate 110. The ends of the conductor rods 104 and 116 are configured as terminals 130A, 130B (FIGS. 2A, 2B). That is, the terminals 130A, 130B of the conductor rods 104 and 116 may be connected to a current or voltage source which supplies electrical current or voltage to the substrate 110 via the conductor rods 104 and 116. One advantage of this embodiment is the use of the catalyst substrate material for temperature control. Heating the catalyst and reactant gases increases the kinematics of (accelerates) the chemical reaction. This also requires energy input to elevate the gas and catalyst temperatures. Conventional systems use a separate heating element for temperature control of the reaction chamber. Using a catalyst substrate 110 which can also serve the function of temperature control (i.e. the substrate 110 is the heating element) enables much higher reactor efficiency as well as quicker heating response time.

As illustrated in FIG. 3A, electrical connections from the terminals 130A, 130B to the spiral substrate 110 may be made such that current flows through the spiral (as illustrated by the spiral arrows in FIG. 3A). That is, one of the terminals 130B may be connected to the outer end 131B of the spiral substrate 110 while the other terminal 130A is connected to the inner end 131A of the spiral substrate 110. Current entering one end 131A, 131B of the spiral substrate 110 spirals through the substrate 110 and enters out the other end 131A, 131B of the spiral substrate 110.

In an embodiment, an optional open region 116 is provided in the recombinator 100 below the first substrate 110. The open region 116 is configured to receive additional substrate structures 110A containing the same catalyst coating as the first substrate 110. The additional substrate structures 110A provide increased surface area for catalyzing the hydrogen halogen reaction but are not directly heated. The heated air exiting the first substrate 110 is at a sufficiently high temperature to sustain additional reactions in this second catalyst substrate region.

A method of operating an embodiment of the recombinator 100 is illustrated in FIG. 2A. In this method, unheated or preheated halogen and hydrogen gases 132 in a gas flow stream are provided in a longitudinal direction to the recombinator 100 through one or more gas inlets 102. The gases entering the recombinator 100 pass from the gas inlet(s) 102 through the diffuser 108. The gas flow 134 spreads and evens laterally across a cross-section of the recombinator 100 below the diffuser 108, resulting in a more even longitudinal gas flow through the recombinator 100.

A voltage source or current source (not shown) is connected to terminals 130A, 130B of the conductor rods 104 and 116 such that a current is supplied to the substrate 110 through the rods 104 and 116. The current from the voltage or current source directly resistively heats the substrate 110 resulting in a heated substrate 136. The heated substrate 136 is preferably heated to a temperature in a range of 100-200° C. The temperature of the substrate may be monitored by any suitable method, such as with thermocouple, an optical pyrometer or a change in resistance of the heated substrate. Additionally, the temperature of the substrate may be reduced or increased by reducing or increasing the electric current in response to the monitored temperature.

FIG. 2B illustrates an alternative configuration of the terminals 130A, 130B for the recombinator 100. In this embodiment, a first terminal 130A is attached to the conductor rod 104 on a first end of the recombinator 100. The conductor rod 104 in turn is electrically connected to a portion or edge of the substrate 110 located in the center of the spiral. The second terminal 130B, in contrast to the embodiment illustrated in FIG. 2A, is located on the same side of the recombinator 100 as the first terminal 130A. The second terminal 130B electrically connected to the outer edge of the substrate 110 such that electric current flows though the spiral substrate 110. In this manner, the substrate 110 may be resistively heated.

As discussed above, the substrate 110 preferably includes a catalyst (e.g., a metal oxide) that catalyzes the hydrogen-halogen reaction. The catalyst is heated by the heated substrate 136 by virtue of being the surface layer of the heated substrate 136 and is also preferably heated to a temperature in a range of 100-200° C. Hydrogen gas and halogen gas flowing over the heated catalyst react to form hydrogen-halogen compound (e.g., HBr) as the gasses flow through the recombinator 100. Gas flow 132, 134 is forced through the recombinator 100 by a pressure differential between the chamber inlet and outlet (either by a pump or by a liquid flow-driven gas suction, e.g. venturi flow). The incoming gases flow through a diffuser 108 which increases the uniformity of the gas flow 134 over the catalyst surface. The expanded substrate (e.g. titanium) mesh acts as a heating element; a voltage differential is applied across its length (e.g., from the spiral center to the outer tail of the spiral) inducing electrical current through the substrate mesh. The electrical resistance of the substrate converts electrical energy into thermal energy, heating the substrate. The elevated temperature of the substrate directly heats the catalyst coating and also releases heat to the gases in the housing 114.

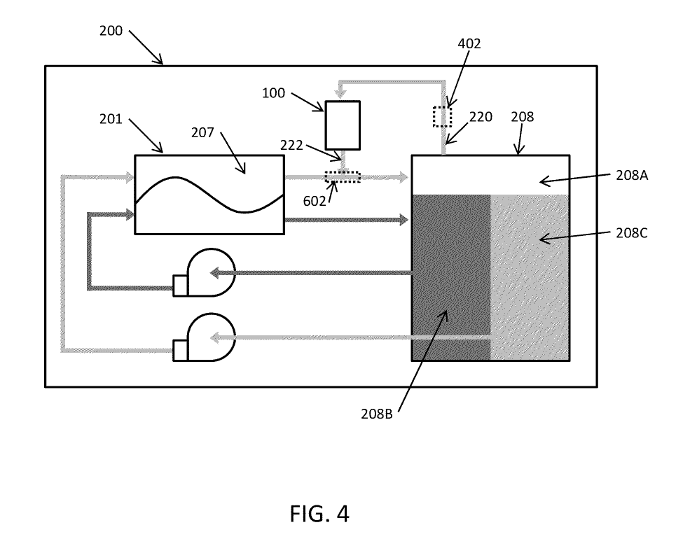

FIG. 4 illustrates a flow battery system 200 and its method of operation during charge mode according to an embodiment. The flow battery system 200 includes one or more flow cells 201. The flow battery system 200 may include a stack of flow cells in which each flow cell does not contain a separator in the reaction zone 207 between the cell's anode and cathode electrodes.

The flow battery system 200 also includes a reservoir 208. The reservoir may contain one or more internal liquid sections as well as one or more internal gaseous sections. In this embodiment, the reservoir 208 includes two liquid segments 208B and 208C, and one gaseous segment 208A. Gaseous species, such as halogen (e.g. Cl₂ or Br₂) and hydrogen gas, are stored in the upper portion 208A (e.g., head space) of the reservoir 208. The reservoir 208 may also include internal structures or filters, not shown.

The flow battery system 200 may also include a pump 402 to provide halogen and hydrogen gas from the upper portion 208A of the reservoir 208 via conduit 220 to the recombinator 100 and combines gas from the recombinator 100 via conduit 222 to the reservoir 208.

Hydrogen gas and bromine gas entrained in the electrolyte has a lower density than the aqueous electrolyte stored in the liquid portion 208B, 208C of the reservoir 208. Thus, the hydrogen gas and bromine gas will tend to segregate or bubble to the upper portion 208A of the reservoir 208. The recombinator 100 relies on having some gaseous bromine present in the headspace (upper portion 208A) of the reservoir 208. At a preferred operating temperature, the vapor pressure of complexed bromine in the electrolyte should release sufficient amounts of bromine into the headspace 208A. As that bromine is consumed by reacting with hydrogen in the recombinator 100, more bromine will naturally evaporate into the gas space 208A.

This re-bromination of the gas space 208A may be accelerated in various ways, such as 1) passing air bubbles through the electrolyte in the reservoir 208, 2) delivering a spray/fountain of a small amount of electrolyte within the headspace 208A of the reservoir 208, and 3) heating a small sample of electrolyte to vaporize the bromine, etc. Two or more of these re-bromination acceleration techniques may be combined.

In one embodiment, a pump 402 draws hydrogen and halogen gases from the top portion 208A of the reservoir 208 via conduit 220 which has an inlet in the upper portion 208A of the reservoir 208 and provides the hydrogen and halogen gases to the recombinator 100. As discussed above, hydrogen and halogen gases react with each other in the recombinator 100 to form a hydrogen-halogen compound. The hydrogen-halogen compound is then returned to the middle portion 208B of the reservoir 208 from the recombinator 100 via conduit 222.

In another embodiment, the pump 402 is replaced with a venturi injector 602, as shown in FIG. 4. Thus, the system preferably contains either the pump 402 or the venturi 602, but in some embodiments the system may contain both of them. Thus, the pump 402 and venture 602 are shown with dashed lines.

As illustrated in FIG. 4, the venturi injector 602 is located such that the electrolyte returning from the reaction zones of the cells 201 to the reservoir 208 passes though the venturi injector 602. In this configuration, the electrolyte is the motive fluid of the venturi injector 602. The vacuum created by the electrolyte passing through the venturi injector 208 draws halogen and hydrogen gases from the upper portion 208A of the reservoir 208 into conduit 220. The gases are drawn through the recombinator 100 where they are combined to form a hydrogen-halogen compound. The hydrogen-halogen compound is drawn into conduit 222 which merges into the venturi injector. The hydrogen-halogen compound mixes with the electrolyte in the venturi injector 602 and the mixture is returned to the reservoir 208.

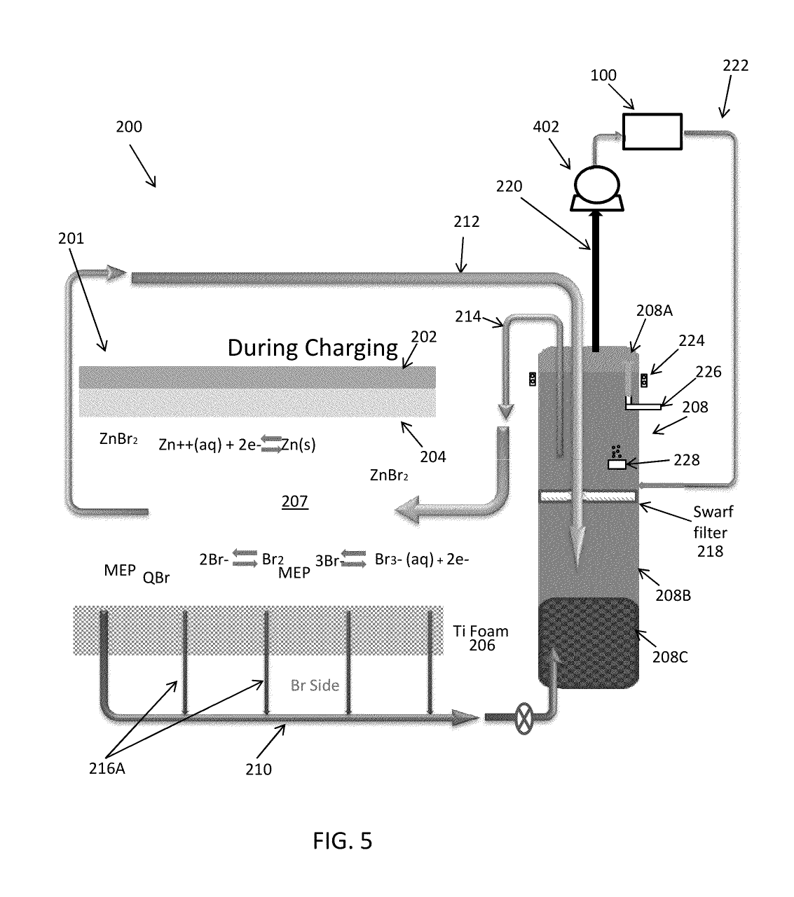

FIG. 5 illustrates a flow battery system 200 and its method of operation during charge mode according to another embodiment. The flow battery system 200 includes one or more flow cells 201, such as a stack of flow cells, in which each cell includes an impermeable electrode 202, which may be made of any suitable material such as titanium. A layer of metal 204, such as zinc, is plated on the impermeable electrode 202. The flow cell 201 also includes a porous (e.g., liquid permeable) electrode 206. The porous electrode 206 may be made of any suitable material, such as a titanium sponge or mesh. A reaction zone 207 is located between and separates the impermeable electrode 202/layer of metal 204 and the porous electrode 206. The flow battery system 200 may include a stack of flow cells in which each flow cell does not contain a separator in the reaction zone 207 between the cell's anode and cathode electrodes 206, 202.

The flow battery system 200 also includes a reservoir 208. In this embodiment, the reservoir 208 oriented vertically and includes an upper portion 208A, a middle portion 208B and a lower portion 208C. Aqueous halogen electrolyte such as zinc chloride and/or zinc bromide, etc., complexed with a complexing agent, (such as a quaternary ammonium bromide (QBr), such as N-ethyl-N-methyl-morpholinium bromide (MEM), N-ethyl-N-methyl-pyrrolidinium bromide (MEP) or Tetra-butyl ammonium bromide (TBA)) is stored in the lower portion 208C of the reservoir 208. The middle potion includes aqueous halogen electrolyte (e.g., ZnCl₂ and/or ZnBr₂) with little or no complexing agent. Gaseous species, such as halogen (e.g. Cl₂ or Br₂) and hydrogen gas are stored in the upper portion 208A (e.g., head space) of the reservoir 208. The reservoir 208 may also include internal structures or filters 218, such as a swarf or another filter 218 in the middle portions 208B of the reservoir 208.

The flow battery system 200 also includes a first conduit 210 which connects the reservoir 208 to the porous electrode 206 via flow channels 216A, a second conduit 212 that connects a distal end or exit of the reaction zone 207 of the fuel cell(s) 201 to the reservoir 208 and a third conduit 214 that connects the reservoir 208 to a proximal and or entrance of the reaction zone 207. The flow battery system 200 may also include a pump 402 to provide halogen and hydrogen gas from the upper portion 208A of the reservoir 208 via conduit 220 to the recombinator 100 and combines gas from the recombinator 100 via conduit 222 to middle portion 208B of the reservoir 208.

In charge mode, aqueous halogen electrolyte is pumped from the middle portion 208B of the reservoir 208 to the reaction zone 207 by a pump (not shown) via conduit 214. Metal, such as zinc plates on the impermeable electrode 202 forming a metal layer 204 in the reaction zone 207. Halogen ions (such as chloride or bromide) in the aqueous electrolyte oxidize to form a diatomic halogen molecule (such as Cl₂, Br₂) on the porous electrode. The halogen molecule may complex with the complexing agent (e.g., MEP). A portion of the aqueous electrolyte flows from the reaction zone 207 through the porous electrode 206, channels 216A and the first conduit 210 into the bottom portion 208C of the reservoir 208. A portion of the hydrogen gas formed during the charging mode flows into the reservoir 208 with this portion of the electrolyte through the porous electrode 206. The complexed bromine is heavier than the aqueous electrolyte and settles in the bottom portion 208C of the reservoir 208. Hydrogen gas in the electrolyte is less dense than the electrolyte and bubbles up into the upper portion 208A of the reservoir 208.

Another portion of the electrolyte flows through the reaction zone 207 to the second conduit 212. This portion of the electrolyte is returned to the middle portion 208B of the reservoir 208 by the second conduit 212. A portion of the hydrogen gas formed during the charging mode flows with this portion of the electrolyte and is returned to the reservoir 208.

Hydrogen gas and bromine gas entrained in the electrolyte has a lower density than the aqueous electrolyte stored in the middle portion 208B of the reservoir 208. Aqueous electrolyte in turn has a lower density than the complexed bromine ions stored in the lower portion 208C of the reservoir 208. Thus, the hydrogen gas and bromine gas will tend to segregate or bubble to the upper portion 208A of the reservoir 208. The recombinator 100 relies on having some gaseous bromine present in the headspace (upper portion 208A) of the reservoir 208. At a preferred operating temperature, the vapor pressure of complexed bromine in the electrolyte should release sufficient amounts of bromine into the headspace 208A. As that bromine is consumed by reacting with hydrogen in the recombinator 100, more bromine will naturally evaporate into the gas space 208A.

As discussed above with respect to FIG. 4, this re-bromination of the gas space 208A may be accelerated in various ways, such as 1) passing air bubbles through the electrolyte in the reservoir 208, 2) delivering a spray/fountain of a small amount of electrolyte within the headspace 208A of the reservoir 208, and 3) heating a small sample of electrolyte to vaporize the bromine, etc. Two or more of these re-bromination acceleration techniques may be combined. These optional features used to agitate and/or heat the electrolyte to aid in bringing hydrogen and halogen gas bubbles trapped in the electrolyte to the upper portion 208A of the reservoir 208 are illustrated in FIG. 5. These optional features include a heater 224 located around a periphery of the reservoir 208, a fountain 226, and a bubbler 228. Although illustrated only in FIG. 5 for simplicity, any of these optional features, either singly or in combination, may be used in all of the embodiments discussed below.

The pump 402 draws hydrogen and halogen gases from the top portion 208A of the reservoir 208 via conduit 220 which has an inlet in the upper portion 208A of the reservoir 208 and provides them to the recombinator 100. As discussed above, hydrogen and halogen gases react with each other in the recombinator 100 to form a hydrogen-halogen compound, such as hydrogen bromide and/or hydrogen chloride. The hydrogen-halogen compound is then returned to the middle portion 208B of the reservoir 208 from the recombinator 100 via conduit 222 which has an outlet in the middle portion 208B of the reservoir 208.

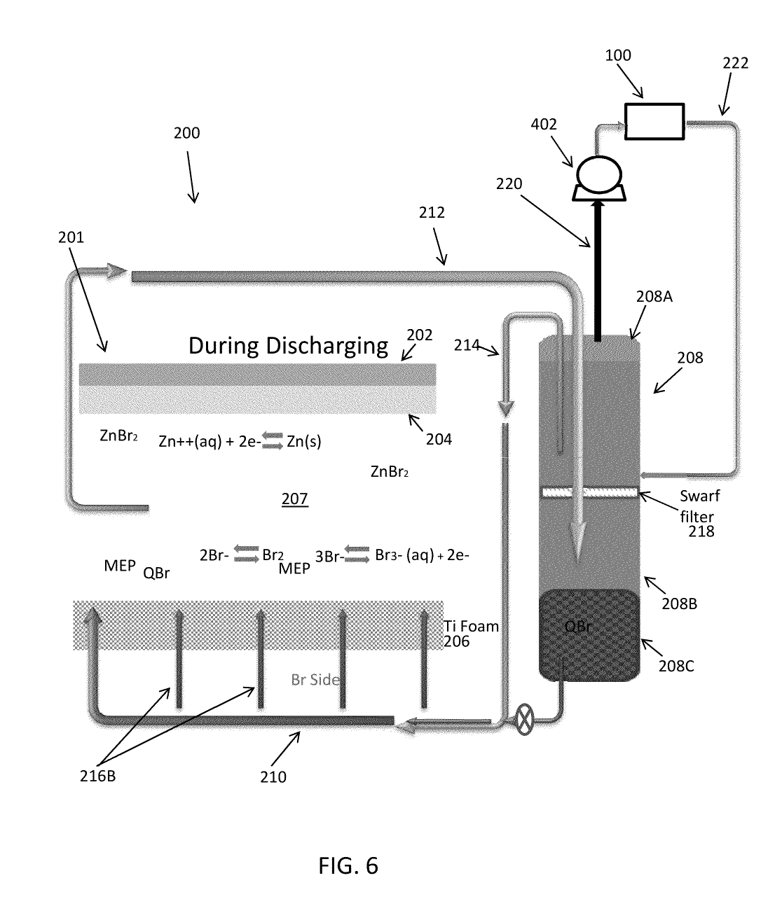

FIG. 6 illustrates the flow battery system 200 and its method of operation during discharge mode according to an embodiment. In discharge mode, the aqueous electrolyte and complexed bromine are provided from the middle portion 208B and the lower portion 208C of the reservoir 208 to the porous electrode 206 via conduits 214, 210 and flow paths 216B, respectively. The electrolyte, including complexed bromine, flows through the porous electrode 206 to the reaction zone 207. On discharge, bromine passing through the porous electrode 206 are reduced by electrons, resulting in the formation of bromine ions. At the same time, the metal layer 204 on the impermeable electrode 202 is oxidized, resulting in metal ions going into solution in the electrolyte. Bromine ions formed in the discharge step are returned to the reservoir 208 via the second conduit 212.

The recombinator 100 may be operated in discharge mode in a similar manner as in charge mode. That is, hydrogen and bromine gases in the upper portion 208C of the reservoir 208 may be pumped to the recombinator 100 via the fourth conduit 220. Hydrogen bromide formed in the recombinator 100 is then provided back to the reservoir 208 via the fifth conduit 222. Furthermore, as discussed above with respect to FIG. 4, in an alternative embodiment, the pump 402 in the system of FIGS. 5 and 6 may be replaced with a venturi injector.

The above embodiment discloses one electrolyte flow configuration. Alternative flow configurations may be used including those illustrated and described in U.S. Pat. No. 8,137,831, hereby incorporated by reference in its entirety.

Although the foregoing refers to particular preferred embodiments, it will be understood that the invention is not so limited. It will occur to those of ordinary skill in the art that various modifications may be made to the disclosed embodiments and that such modifications are intended to be within the scope of the invention. All of the publications, patent applications and patents cited herein are incorporated herein by reference in their entirety.

What is claimed is:

1. A recombinator for a flow battery comprising:
at least one input configured to provide a halogen containing flow stream and hydrogen gas to a reaction chamber; and
a substrate located in the reaction chamber, wherein the substrate is configured to be directly heated and the substrate contains a catalyst,
wherein the recombinator is configured to react the hydrogen gas and the halogen using the catalyst to form a hydrogen-halogen compound.

2. The recombinator of claim 1, wherein the substrate comprises a mesh.

3. The recombinator of claim 2, wherein the mesh is configured as a spiral.

4. The recombinator of claim 1, wherein the substrate is corrugated.

5. The recombinator of claim 1, wherein the substrate comprises titanium.

6. The recombinator of claim 1, wherein the catalyst comprises a substantially platinum free metal oxide.

7. The recombinator of claim 6, wherein the catalyst comprises zero to less than 1 wt % platinum.

8. The recombinator of claim 6, wherein the metal oxide comprises one or more oxides of ruthenium, iridium, titanium, tantalum, tin, tungsten, aluminum, zirconium, molybdenum, palladium, and silicon.

9. The recombinator of claim 1, wherein the substrate comprises a corrugated titanium mesh configured as a spiral, the spiral comprises insulation between adjacent mesh layers in the spiral and the catalyst comprises a substantially platinum free mixed metal oxide.

10. The recombinator of claim 8, wherein the mixed metal oxide comprises two or more oxides of ruthenium, iridium, titanium, tantalum, tin, tungsten, aluminum, zirconium, molybdenum, palladium, and silicon.

11. The recombinator of claim 1, wherein the at least one input is a common halogen containing flow stream and hydrogen gas input.

12. The recombinator of claim 1, wherein:
the halogen comprises bromine vapor;
the recombinator is configured to react the hydrogen gas and the bromine vapor using the catalyst to form the hydrogen-halogen compound; and
the hydrogen-halogen compound comprises hydrogen bromide.

13. The recombinator of claim 1, further comprising a diffuser configured to diffuse gas provided to the reaction chamber.

14. The recombinator of claim 1, wherein the substrate is connected to a current or voltage source and is configured to be directly heated by electrical current passed through the substrate.

15. The recombinator of claim 1, wherein the reaction chamber is configured to hold a plurality of substrates.

16. A flow battery system comprising:
the recombinator of claim 1; and
an aqueous halogen flow battery.

17. The flow battery system of claim 16, wherein the halogen comprises bromine and the flow battery is a zinc-bromine flow battery.

18. The flow battery system of claim 17, further comprising an aqueous zinc bromide electrolyte reservoir.

19. The flow battery system of claim 18, further comprising a pump or a venturi injector configured to provide bromine vapor from the reservoir to the recombinator.

20. The flow battery system of claim 16, wherein the flow battery comprises a stack of flow cells in which each flow cell does not contain a separator in a reaction zone between the cell's anode and cathode electrodes.

21. A method of operating a recombinator comprising:
providing a halogen containing flow stream to a recombinator comprising a directly heated substrate comprising a catalyst;
providing hydrogen gas to the recombinator; and
reacting the halogen with the hydrogen gas using the catalyst to form a hydrogen-halogen compound.

22. The method of claim 21, wherein the substrate is directly heated to a temperature in a range of 100-200° C.

23. The method of claim 22, wherein the substrate is directly heated by passing an electric current through the substrate to directly heat the substrate.

24. The method of claim 23, further comprising monitoring the temperature of the substrate and reducing or increasing the electric current in response to the monitored temperature.

25. The method of claim 24, wherein the temperature is monitored with thermocouple, an optical pyrometer or a change in resistance of the heated substrate.

26. The method of claim 21, wherein the catalyst comprises a substantially platinum free metal oxide.

27. The method of claim 21, further comprising passing the hydrogen gas through a diffuser prior to reacting the halogen containing flow stream with the hydrogen gas.

28. The method of claim 21, wherein:
the halogen comprises bromine;
the halogen containing flow stream comprises bromine vapor;
the hydrogen gas and the bromine vapor react using the catalyst to form the hydrogen-halogen compound; and
the hydrogen-halogen compound comprises hydrogen bromide.

29. A recombinator for a flow battery comprising:
at least one input configured to provide a halogen containing flow stream and hydrogen gas to a reaction chamber; and
a substrate located in the reaction chamber, wherein the substrate contains a substantially platinum free metal oxide catalyst,
wherein the recombinator is configured to react the hydrogen gas and the halogen using the catalyst to form a hydrogen-halogen compound.

30. The recombinator of claim 29, wherein the metal oxide comprises one or more oxides of ruthenium, iridium, titanium, tantalum, tin, tungsten, aluminum, zirconium molybdenum, palladium, and silicon.

31. The recombinator of claim 29, wherein the substrate comprises a corrugated titanium mesh configured as a spiral, the spiral comprises insulation between adjacent mesh layers in the spiral and the catalyst comprises a mixed metal oxide.

32. The recombinator of claim 31, wherein the mixed metal oxide comprises two or more oxides of ruthenium, iridium, titanium, tantalum, tin, tungsten, aluminum, zirconium molybdenum, palladium, and silicon.
